(19) United States
(12) Patent Application Publication
(10) Pub. No.: US 2025/0245025 A1
(43) Pub. Date: Jul. 31, 2025

(54) MEDIATE DIGITAL IDENTITIES ACROSS VIRTUAL ENVIRONMENTS

(71) Applicant: INTERNATIONAL BUSINESS MACHINES CORPORATION, Armonk, NY (US)

(72) Inventors: Eric Gendreau, New York, NY (US); NEIL DELIMA, Scarborough (CA); Tiberiu Suto, Franklin, NY (US); Susan Aboelela, Cliffside Park, NJ (US); Jennifer M. Hatfield, Portland, OR (US); Alissa Buck, Turtle Creek, PA (US); Jeremy R. Fox, Georgetown, TX (US)

(21) Appl. No.: 18/427,203

(22) Filed: Jan. 30, 2024

(51) Int. Cl. G06F 9/445; G06F 16/28; G06T 11/00

(52) U.S. Cl. CPC G06F 9/4451; G06F 16/285; G06T 11/00

(57) ABSTRACT

A computer-implemented method for identifying, by a processor set, a cluster of users by learning from their interactions in a first virtual environment. The processor set may further classify characteristics of an avatar associated with each user of the cluster of users in the first virtual environment and generate a secure portal visible only to users of the cluster of users to teleport to a second virtual environment. The processor set may also generate a guest profile and a guest avatar in the second virtual environment for each user of the cluster of users. The processor may also adapt the guest avatar for each user of the cluster of users based on a theme of the second virtual environment and generate a new profile prefilled with data collected from previous virtual environments that contain a subset of profile data required for the second virtual environment.

### BACKGROUND

Aspects of the present invention relate generally to mediating digital identities across virtual environments and, more particularly, to improving a user's ability to move more efficiently between one or more virtual environments.

Immersive virtual reality experiences have been gaining more momentum with all the buzz around the Metaverse. Over time more and more “metaverses” are being created online, in digital-native spaces for collaboration, and on social engagement platforms. When engaging in a metaverse or any immersive virtual experience, users can interact within a group and develop friendships and connections with other users on the platform.

### SUMMARY

In a first aspect of the invention, there is a computer-implemented method including: identifying, by a processor set, a cluster of users by learning from their interactions in a first virtual environment; classifying, by the processor set, characteristics of an avatar associated with each user of the cluster of users in the first virtual environment; generating, by the processor set, a secure portal visible only to users of the cluster of users to teleport to a second virtual environment; generating, by the processor set, a guest profile and a guest avatar in the second virtual environment for each user of the cluster of users, where the guest avatar is based on the avatar associated with each user of the cluster of users in the first virtual environment; adapting, by the processor set, the guest avatar for each user of the cluster of users based on a theme of the second virtual environment; and generating, by the processor set, a new profile prefilled with data collected from previous virtual environments that contain a subset of profile data required for the second virtual environment.

In another aspect of the invention, there is a computer program product including one or more computer readable storage media having program instructions collectively stored on the one or more computer readable storage media. The program instructions are executable to: identify a cluster of users by learning from their interactions in a first virtual environment; classify, characteristics of an avatar associated with each user of the cluster of users in the first virtual environment; generate a secure portal visible only to the users of the cluster of users to teleport to a second virtual environment; generate a guest profile and a guest avatar in the second virtual environment for each user of the cluster of users, where the guest avatar is based on the avatar associated with each user of the cluster of users in the first virtual environment; adapt the guest avatar for each user of the cluster of users based on a theme of the second virtual environment; and generate a new profile prefilled with data collected from previous virtual environments that contain a subset of profile data required for the second virtual environment.

In another aspect of the invention, there is a system including a processor set, one or more computer readable storage media, and program instructions collectively stored on the one or more computer readable storage media. The program instructions are executable to: identify a cluster of users by learning from their interactions in a first virtual environment; classify, characteristics of an avatar associated with each user of the cluster of users in the first virtual environment; generate a secure portal visible only to users of the cluster of users to teleport to a second virtual environment; generate a guest profile and a guest avatar in the second virtual environment for each user of the cluster of users, where the guest avatar is based on the avatar associated with each user of the cluster of users in the first virtual environment; adapt the guest avatar for each user of the cluster of users based on a theme of the second virtual environment; and generate a new profile prefilled with data collected from previous virtual environments that contain a subset of profile data required for the second virtual environment.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3A-3C show a flowchart of an exemplary method in accordance with aspects of the present invention.

### DETAILED DESCRIPTION

Aspects of the present invention relate generally to virtual platform management and, more particularly, to mediating digital identities across multiple virtual environments. In embodiments, a user or group of users are enabled to collectively move from one metaverse or virtual experience to another, without the need for all users to exit their current metaverse session, sign-in to a different session in another metaverse and start a new group activity, thereby improving the user's (or group of user's) ability to move (e.g., teleport) more efficiently between one or more virtual environments (e.g., metaverses). Additionally, users may maintain multiple digital aliases across these different metaverses but still maintain a persistent “digital identity.” This still allows users to participate in different metaverses using different aliases but enables them to seamlessly modulate between these aliases when themselves or a group move from one metaverse (i.e., virtual environment) to another.

According to an aspect of the invention, there is a computer-implemented method for teleporting a user or a group of users from one virtual environment to another while preserving an identity and an avatar representation and adapting avatar characteristics to an environment of a destination, the computer-implemented method including: identifying a cluster of users based on learned interactions of the user or the group of users in a first virtual environment; classifying and labeling the characteristics of an avatar of the user or the group of users in the first virtual environment; generating a secure portal visible only to the user or the group of users, where the portal is utilized to teleport the user or the group of users to a target environment; generating guest avatar profiles for the user or the group of users in the target environment using generative artificial intelligence (AI) methods and labelled characteristics as prompts from the first environment; adapting an appearance and digital accessories of the avatar based on the theme of the target environment; collecting and aggregating information from multiple previous platforms, where each of the multiple previous platforms contain a subset of profile data required for a new platform; and generating a new profile prefilled with the aggregated information.

Immersive virtual reality experiences have been gaining ever more momentum with buzz around the Metaverse. Over time more and more “metaverses” are being created online, in digital-native spaces for collaboration, and on social engagement platforms. These virtual environments (i.e., metaverses) are generally controlled by different companies and/or entities and are built using numerous disparate architectures and protocols, resulting in disjointed experiences across the various virtual environments and/or platforms.

When engaging in a virtual environment (i.e., metaverse) or any immersive virtual experience, users often interact within a group of users and often find themselves moving from one experience to another or from one virtual environment to another. However, moving from one experience to another or from one virtual environment to another using existing technologies is cumbersome, particularly when a user does not have an identity on/in the new virtual environment. In such instances, the user must create an account on the new virtual environment before joining the new virtual environment, which can be time consuming and laborious.

The foregoing issues in the existing technologies are compounded when a group of users would like to move from one experience to another or from one virtual environment to another together as a group. In these situations, all of the users within the group generally exit out of their current virtual session within the first virtual environment, start a second virtual experience, and either log into the second virtual experience, likely using a different alias and/or different login credentials, or create a new account in the second virtual environment. After completing these steps, each user must then locate the rest of the users in the group by either meeting at a predetermined spot within the virtual environment, or use that metaverse's tools to find their groupmates, who may also go by different aliases in the second virtual environment and start a new virtual session for the group.

In short, the existing technologies are not equipped to allow users to efficiently move from one experience to another or from one virtual environment to another. Indeed, the existing technologies result in inefficient practices that are not only time consuming, but they generally leave users frustrated.

The issues created by existing technologies are further highlighted using real world examples. For example, ten users log into a first virtual environment to attend an important 30-minute business meeting being held via video conference. However, as the meeting attendees log into the first virtual environment, it is realized and/or learned that the first virtual environment is lagging and does not have the bandwidth and/or capabilities to support the meeting at that date and time. The meeting organizer determines that the meeting should be moved to a second virtual environment, but only half of the meeting attendees have an account on the second virtual environment. As a result, five of the meeting attendees must create an account on/with the second virtual environment, download new software for the second virtual environment, log into the second virtual environment, adjust settings based on the user's preferences, and then join the meeting. By the time all ten meeting attendees have joined the meeting on the second virtual environment, there are only a few minutes left during the scheduled time and the meeting organizer spends the remaining meeting time finding the next 30-minute window when the group can meet again. In this example, the inefficiencies of the existing technologies resulted in an expensive loss of time and resources for each of the meeting attendees and their respective employers.

Embodiments and aspects of the invention provide a system and method that improves and advances the technology in a specific and practical application. In other words, embodiments and aspects of the invention improve a user's ability to move more efficiently through one or more virtual environments (e.g., metaverses). For example, according to aspects of the invention, the system and method may identify a cluster of users by learning from their interactions in a first virtual environment; classify characteristics of an avatar associated with each user of the cluster of users in the first virtual environment; generate a secure portal visible only to users of the cluster of users to teleport to a second virtual environment. According to additional aspects of the invention, the system and method may further generate a guest profile and a guest avatar in the second virtual environment for each user of the cluster of users, where the guest avatar is based on the avatar associated with each user of the cluster of users in the first virtual environment; adapt the guest avatar for each user of the cluster of users based on a theme of the second virtual environment; and generate a new profile prefilled with data collected from previous virtual environments that contain a subset of profile data required for the second virtual environment. Each of these aspects, alone and in combination, help improve a improve a user's ability to move more efficiently through one or more virtual environments (e.g., metaverses).

Implementations of the invention are necessarily rooted in computer technology. For example, at least the steps of generating a secure portal visible only to users of the cluster of users to teleport to a second virtual environment, generating a guest profile and a guest avatar in the second virtual environment for each user of the cluster of users, and generating, by the processor set, a new profile prefilled with data collected from previous virtual environments that contain a subset of profile data required for the second virtual environment, are computer-based, are very complex, and cannot be performed in the human mind. Given the scale and complexity required to perform the foregoing tasks, it is simply not possible for the human mind, or for a person using pen and paper, to perform the number of calculations involved in identifying a cluster of users by learning from their interactions in a first virtual environment, classifying characteristics of an avatar associated with each user of the cluster of users in the first virtual environment, generating a secure portal visible only to users of the cluster of users to teleport to a second virtual environment, generating a guest profile and a guest avatar in the second virtual environment for each user of the cluster of users where the guest avatar is based on the avatar associated with each user of the cluster of users in the first virtual environment, and adapting the guest avatar for each user of the cluster of users based on a theme of the second virtual environment.

Furthermore, training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. The values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example: a user's name, alias, image, likeness, and/or other personal/identifying information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as user/group teleportation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

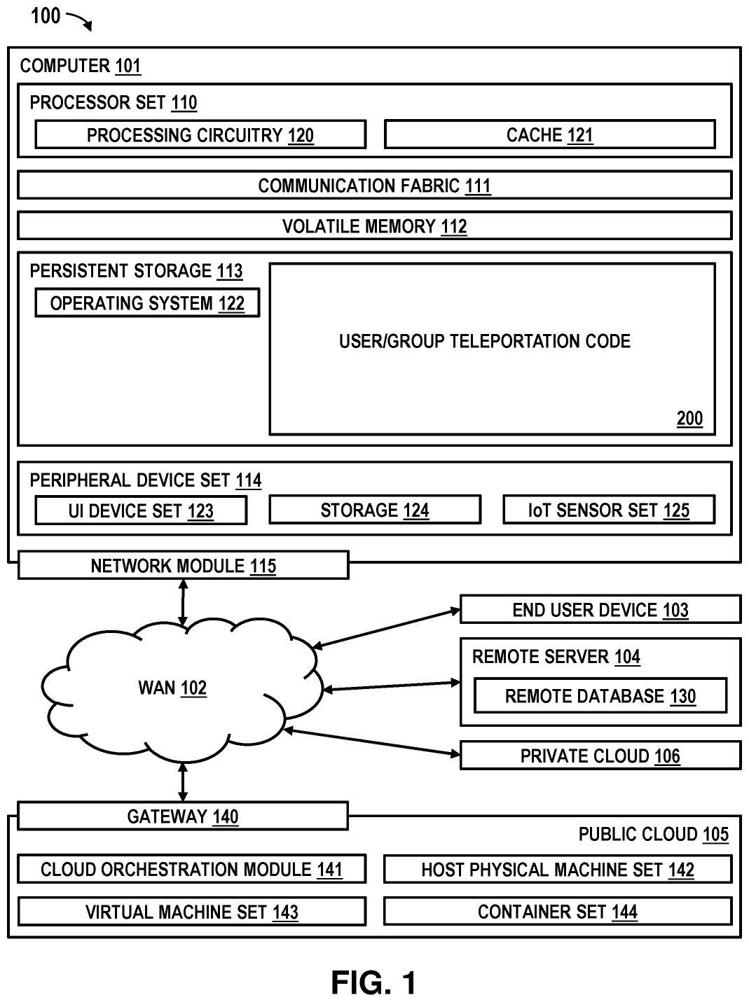

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

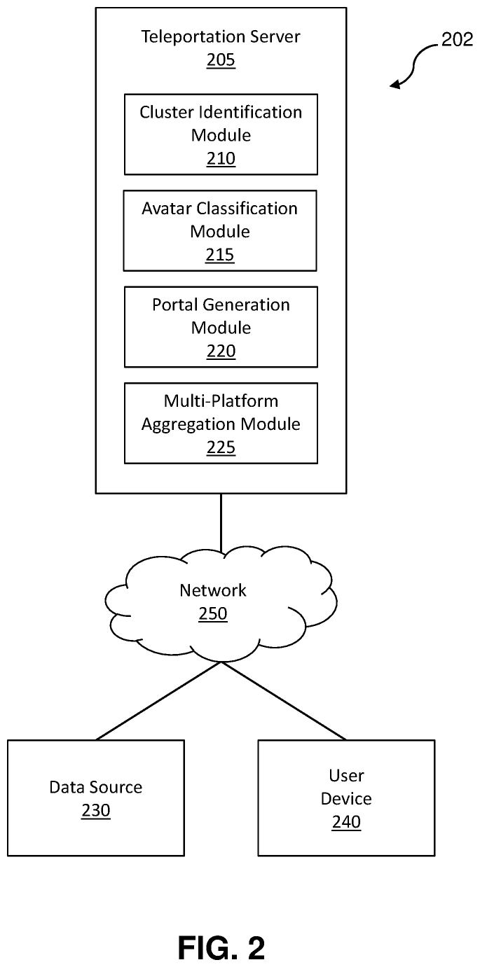

FIG. 2 shows a block diagram of exemplary environment 202 in accordance with aspects of the invention. In embodiments, environment 202 includes teleportation server 205, data source 230, user device 240, and network 250.

Teleportation server 205 may comprise one or more instances of computer 101 of FIG. 1. In another example, teleportation server 205 may comprise one or more virtual machines or containers running on one or more instances of computer 101 of FIG. 1. In embodiments, teleportation server 205 communicates with data source 230 and user device 240 via network 250, which may comprise WAN 102 of FIG. 1. In embodiments, data source 230 comprises one or more data sources each comprising an instance of remote database 130 and/or remote server 104 of FIG. 1. In embodiments, user device 240 comprises one or more instances of EUD 103 of FIG. 1. There may be plural different instances of user device 240 including, for example, user-accessible servers and/or personal computing devices. The different instances of user device 240 may be used by different users and evaluators, respectively.

In embodiments, teleportation server 205 of FIG. 2 comprises cluster identification module 210, avatar classification module 215, portal generation module 220, and multi-platform aggregation module 225, each of which may comprise modules of user/group teleportation code of block 200 of FIG. 1. Such modules may include routines, programs, objects, components, logic, data structures, and so on that perform a particular task (or tasks) or implement a particular data type (or types) that the user/group teleportation code of block 200 uses to carry out the functions and/or methodologies of embodiments of the invention as described herein. These modules of user/group teleportation code of block 200 are executable by computer 101 of FIG. 1 (e.g., processing circuitry 120 of FIG. 1) to perform the inventive methods as described herein. Teleportation server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, cluster identification module 210 is configured to identify a cluster of users by learning from their interactions in a first virtual environment. In embodiments, cluster identification module 210 may additionally log interactions between users in the first virtual environment and additional virtual environments, identify a cluster of users using machine learning clustering methods, receive user input comprising at least one self-identified network of users, and/or determine a group leader from the cluster of users.

In accordance with aspects of the invention, avatar classification module 215 is configured to classify and/or label characteristics of an avatar associated with each user of the cluster of users in the first virtual environment. In embodiments, avatar classification module 215 may additionally receive updated appearance/characteristics of the avatar associated with a first user, generate labels that describe the appearance/characteristics of each user avatar, and/or store the labels as metadata describing the first virtual environment. As used herein, a label may comprise a textual description of an object, avatar, or an object within an avatar.

In additional embodiments avatar classification module 215 is further configured to adapt each guest avatar in the second virtual environment. In embodiments, avatar classification module 215 may additionally generate a representation of a user avatar from the first virtual environment in the second virtual environment and reconstruct each guest avatar using labels for the second virtual environment and personal user characteristics using generative artificial intelligence methods.

In accordance with aspects of the invention, portal generation module 220 is configured to generate a secure portal visible only to the cluster of users to teleport to a second/target environment. In embodiments, portal generation module 220 may additionally maintain a temporary session-based record for a user group with pointers to current profiles, create a new virtual environment session in a second virtual environment, generate an invitation to join the new virtual session in the second virtual environment, and publish a link or button for the cluster of users to join the new virtual session in the second virtual environment.

In accordance with aspects of the invention, multi-platform aggregation module 225 is configured to generate a new profile prefilled with data collected and aggregated from previous platforms that contain a subset of the profile data required for the second virtual environment.

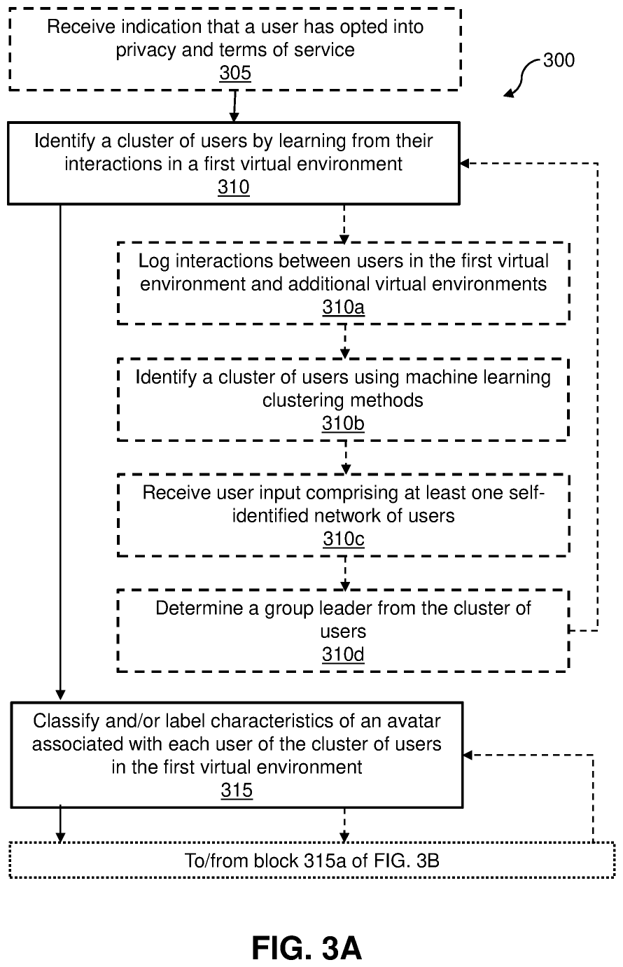

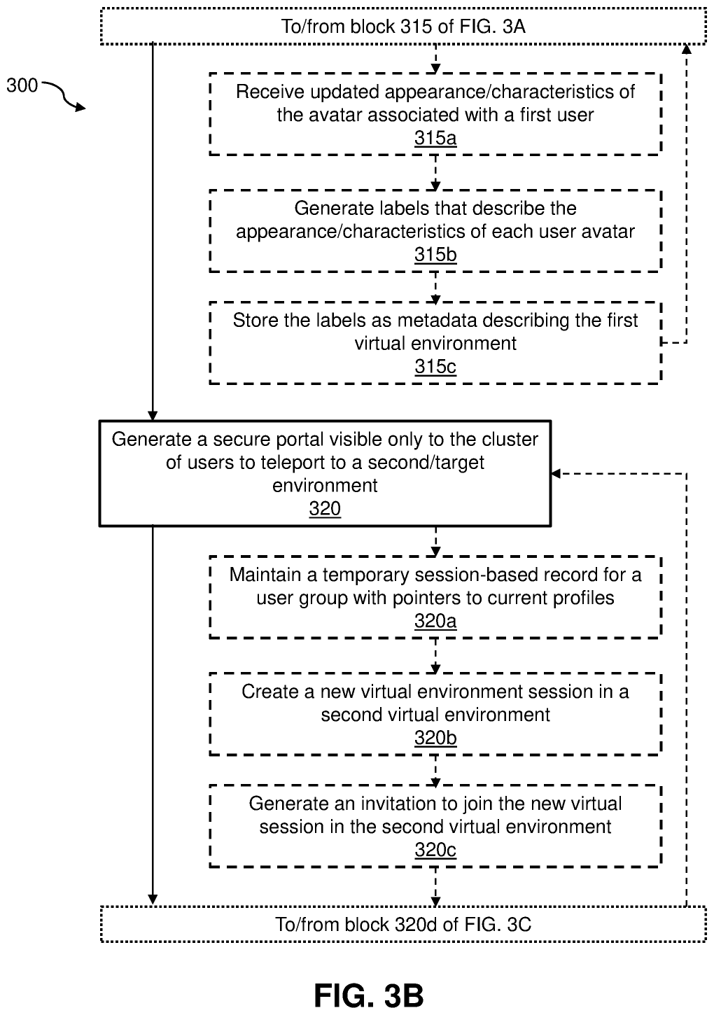

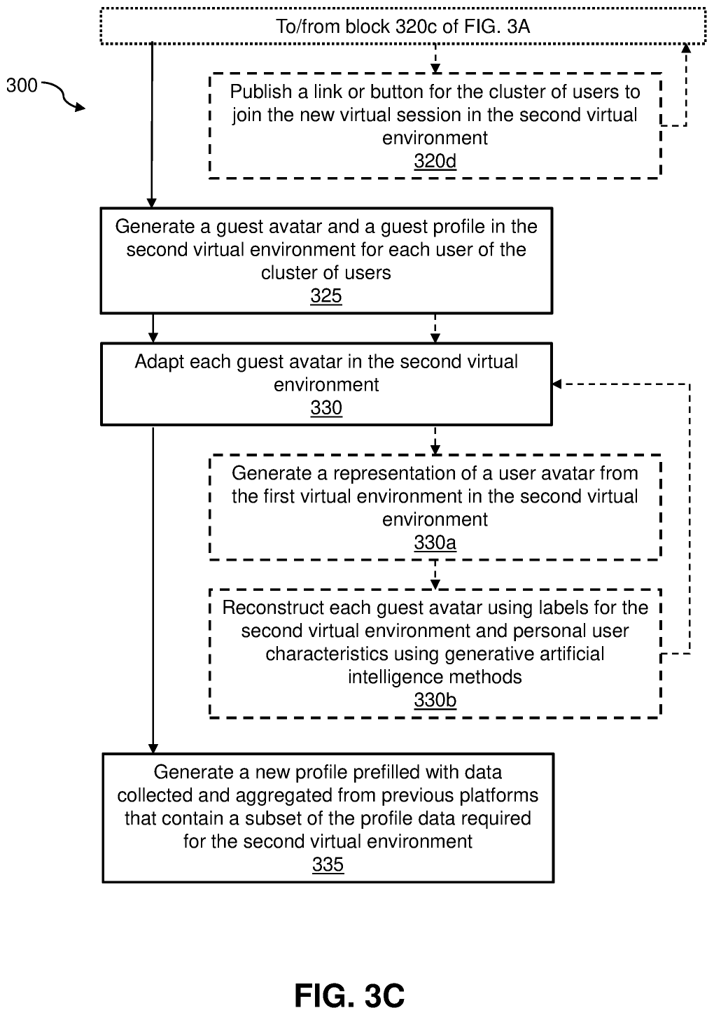

FIGS. 3A-C show a flowchart of an exemplary method 300 in accordance with aspects of the present invention. Steps of method 300 may be carried out in the environment of FIG. 2 and are described with reference to elements depicted in FIG. 2.

At block 310, teleportation server 205 of FIG. 2 is configured to optionally receive an indication that a user has opted into privacy and terms of service. As noted above, it should be understood that, to the extent implementations of the invention collect, store, or employ personal information provided by, or obtained from, individuals (for example: a user's name, alias, image, likeness, and/or other personal/identifying information), such is used in accordance with all applicable laws concerning protection of personal information. Additionally, the collection, storage, and use of such information may be subject to consent of the individual to such activity, for example, through “opt-in” or “opt-out” processes, such as that of block 305, as may be appropriate for the situation and type of information.

At block 310, cluster identification module 210 of FIG. 2 is configured to identify a cluster of users by learning from their interactions in a first virtual environment. In embodiments, the virtual environment and/or virtual environment catalog may be extended to provide a mechanism to capture data and metadata related to the category, genre, and other key attributes of the virtual experience and virtual interface to access this information. In embodiments, the virtual environment and/or virtual environment catalog may be extended to provide a mechanism and interface to authenticate, manage/maintain user profiles, manage/maintain guest, and/or session-based users and user groups. Using the extended virtual environment and/or virtual environment catalog, teleportation server 205 of FIG. 2 learns from user interactions in a first virtual environment identify a cluster of users.

In embodiments, identifying a cluster of users in accordance with block 310 may further comprise one or more of the features of blocks 310a-d of FIG. 3A. Specifically, at block 310a, cluster identification module 210 may optionally identify a cluster of users by logging interactions between users in the first virtual environment and additional virtual environments. As used herein, interactions may include communications and/or actions. For example, when one or more users communicate via text, chat, voice, gestures, or any other method of communication used in a virtual environment, cluster identification module 210 identifies users that may belong to the same cluster (e.g., group, team, and/or cohort) of users. Furthermore, cluster identification module 210 identifies users that may belong to the same cluster based on actions such as simultaneous game play, joining the same group, team, and/or cohort, requesting to join the group, team, and/or cohort, and/or interacting with the virtual environment in the same ways.

The logging of block 310a may further include logging a number of interactions, the frequency of interaction within a virtual session, the type of interaction, and/or an emotional score using existing natural language understanding of the conversations. As used herein, the emotional score may comprise a quality of interactions (i.e., sentiment) between users. Specifically, the communications between users may be analyzed using natural language to determine whether the users are on good terms, are friendly, and/or have a positive relationship (e.g., a higher emotional score). Similarly, the communications between users may be analyzed using natural language to determine whether the users are on bad terms, are unfriendly, and/or have an adversarial or negative relationship (e.g., a lower emotional score). In such embodiments, the emotional score may be used to further define a cluster of users. In embodiments, the logging of block 310a may be performed or captured across multiple virtual sessions within a single virtual environment and/or multiple virtual environments.

In embodiments, at block 310b, cluster identification module 210 may optionally identify a cluster (e.g., group, team, and/or cohort) of users using machine learning clustering methods. As used herein, machine learning clustering methods may comprise, for example, density-based algorithms, distribution-based algorithms, centroid-based algorithms, hierarchical-based algorithms, k-means clustering algorithms, density-based spatial clustering of applications with noise (DBSCAN) algorithms, Gaussian mixture model algorithms, balance iterative reducing and clustering using hierarchies (BIRCH) algorithms, affinity propagation clustering algorithms, mean-shift clustering algorithms, ordering points to identify the clustering structure (OPTICS) algorithms, agglomerative hierarchy clustering algorithms, or any combination thereof. The foregoing algorithms may be used to determine connections between users and thereby identify a cluster of users within the first virtual environment. The data obtained from the foregoing machine learning clustering methods can be further extended to build a graph or network of connected users that can be traversed using existing graph algorithms.

In embodiments, at block 310c, cluster identification module 210 may optionally identify a cluster of users by receiving user input comprising at least one self-identified network of users. In other words, a user may self-identify as belonging to a specific group, team, and/or cohort. For example, a user may expressly indicate an affiliation with (or membership of) a specific team of users within a virtual environment. In such embodiments, the user input may be received by cluster identification module 210 from user device 240 via network 250.

In embodiments, at block 310d, cluster identification module 210 may optionally identify a cluster of users by determining a group leader from the cluster of users. In other words, a leader of the group, team, and/or cohort may be identified based on the logging, identifying, and user input described with respect to blocks 310a-c above. In embodiments, the identified user has at least an avatar and profile on a first virtual environment and at least a profile on a second virtual environment, where the second virtual environment is a target virtual environment that a user or group of users may be teleported to at a future time. In such embodiments, it is possible that cluster identification module 210 may determine multiple group leaders based on different possible second virtual environments (i.e., target virtual environments). In embodiments, cluster identification module 210 may use the determined group leader to find additional users that might belong to the cluster of users. In embodiments, the group leader may be determined based on a user having the greatest number of cluster members following them or having the greatest number of connections within the cluster within an existing virtual session. In embodiments, secondary group leaders may be selected using the foregoing techniques.

At block 315, avatar classification module 215 is configured to classify and/or label characteristics of an avatar associated with each user of the cluster of users in the first virtual environment. In embodiments, when a user logs into the first virtual environment the user may be required to authenticate a profile with the appropriate credentials. When a user's profile is retrieved, an associated avatar (or avatars) is also retrieved and are ready (or made ready) to interact in the virtual environment. In embodiments, the user may update the appearance of the avatar(s) and add accessories such as clothing and other gear to enhance the appearance of the avatar using existing mechanisms in virtual experiences. Accordingly, avatar classification module 215 classifies and/or labels characteristics of an avatar associated with each user of the cluster of users in the first virtual environment.

In embodiments, classifying and/or labelling characteristics of an avatar associated with each user of the cluster of users in accordance with block 315 may further comprise one or more of the features described with respect to blocks 315a-c of FIG. 3B. Specifically, at block 315a, avatar classification module 215 may classify and/or label characteristics by receiving updated appearance/characteristics of the avatar associated with a first user. As noted above, this may include receiving a completely new avatar, a new and/or updated appearance of a current or previous avatar, and new and/or updated accessories such as clothing and other gear to enhance the appearance of the current or previous avatar.

In embodiments, at block 315b, avatar classification module 215 may optionally classify and/or label characteristics of an avatar by generating labels that describe the appearance and/or characteristics of a user's avatar. In embodiments, the virtual environment and/or virtual environment catalog may be extended to for visual recognition and automated image/object labeling, to generate labels or classes that describe the characteristics of the avatar and accessories. In embodiments, this may further include receiving user-defined labels for the avatars and accessories associated with the user. In embodiments, avatar classification module 215 may comprise a mechanism and/or interface to store the classification and/or label data in a user's profile and avatar classification module 215 may be configured to retrieve and update a user's avatar and accessories as they are changed/updated.

In embodiments, at block 315c, avatar classification module 215 may optionally classify and/or label characteristics of an avatar by storing created labels as metadata describing the first virtual environment. In other words, avatar classification module 215 may use existing visual recognition and image labelling techniques to generate labels (or classes) that describe the characteristics of a current virtual environment and/or additional available virtual environments. As noted with respect to block 315b, these labels can be stored as metadata that describes the current virtual environment and/or additional available virtual environments.

At block 320, portal generation module 220 is configured to generate a secure portal visible only to the cluster of users to teleport to a second/target environment. In embodiments, generating a secure portal to teleport to a second/target environment in accordance with block 320 may further comprise one or more of the features described with respect to blocks 320a-c of FIG. 3B and block 320d of FIG. 3C.

In embodiments, at block 320a, portal generation module 220 may optionally maintain a temporary session-based record for a user group with pointers to a current user profile (or profiles). In embodiments, portal generation module 220 may further identity/determine whether a user profile exists and, if a profile does not exist, determine whether a temporary guest identity has been generated in the virtual environment for a user of the cluster of users.

In embodiments, at block 320b, portal generation module 220 may optionally generate a secure portal to teleport to a second/target environment by creating a new virtual session in a second virtual environment. In embodiments the creation of the new virtual session may be triggered when a cluster (e.g., group, team, and/or cohort) of users in one environment decides that they wish to engage in activities in a second virtual environment. In embodiments, the second virtual environment may be a virtual environment where one, some, or all of the users of the cluster of users may have a profile and/or identity. In such embodiments, portal generation module 220 may use an identity of an identified group leader or any other user that already has a profile and/or identity in the second (e.g., target) virtual environment, to create the new virtual session in the second (e.g., target) virtual environment. In embodiments, the second virtual environment may be the same virtual environment but controlled and/or managed by a different entity or company.

In embodiments, at block 320c, portal generation module 220 may optionally generate a secure portal to teleport to a second/target environment by generating an invitation to join the new virtual session in the second virtual environment. In embodiments, portal generation module 220 uses second virtual environment application program interfaces (APIs) to create a secure web meeting invite, link, tokens, and/or graphical user interface (GUI) button to enable users to navigate to the new virtual session in the second virtual environment. In embodiments, the virtual environment and/or virtual environment catalog may be further extended to provide a mechanism for generating a join uniform resource locator (URL).

In embodiments, at block 320d of FIG. 3C, portal generation module 220 may optionally generate a secure portal to teleport to a second/target environment by publishing a meeting invite (e.g., a link, token, or button) for the cluster of users to join the new virtual session in the second virtual environment. In such embodiments, users of the cluster of users transition from the first virtual environment to the second virtual environment by engaging (e.g., clicking, pressing, selecting) the meeting invite link, token, and/or button in the first virtual environment. In embodiments, the meeting invite link, token, and/or button is only made visible to users that belong to the cluster of users.

At block 325, portal generation module 220 is configured to generate a guest avatar and a guest profile in the second virtual environment for each user of the cluster of users that does not already have an avatar and/or profile on the second virtual environment. In other words, upon engaging (e.g., clicking, pressing, selecting) a meeting invite link, portal generation module 220 creates a temporary ID and/or account, including a guest avatar and a guest profile. In embodiments, the temporary ID and/or account expires after a current session is closed and/or upon the creation of a new non-temporary user account in the second virtual environment. In embodiments, the temporary ID and/or account does not expire until some profile information, including for example, identity, role, permissions, characteristics of a user's avatar, a list of accessories and their descriptions, and/or other data has been transferred to the second virtual environment. In embodiments, the group leader's profile (or another member of the group's profile) may be used as a template for creating the guest avatar and/or guest profile for new users on the second virtual environment.

At block 330, avatar classification module 215 is configured to adapt each guest avatar in the second virtual environment. In embodiments, adapting each guest avatar in accordance with block 330 may further comprise one or more of the features described with respect to blocks 330a-b of FIG. 3C.

In embodiments, at block 330a, avatar classification module 215 may optionally adapt a guest avatar in the second virtual environment by generating a representation of a user avatar from the first virtual environment in the second virtual environment. Specifically, using existing foundation models trained with avatar characteristic metadata, prompt tuning, and generative AI methods for image reconstruction, avatar classification module 215 may generate a representation of a user's avatar, based on that user's avatar in the first virtual environment, using avatar metadata classifications and/or labels as visual prompts to the generative AI solution. In embodiments, personal user characteristics may additionally (or alternatively) be used to generate and/or reconstruct each guest avatar using generative AI methods.

In embodiments, at block 330b, avatar classification module 215 may optionally adapt a guest avatar in the second virtual environment by reconstructing each guest avatar using classifications and/or labels for the second virtual environment using generative AI methods. In additional embodiments, avatar classification module 215 may use existing generative AI methods for image reconstruction, generate customized accessories or clothing for each avatar that is appropriate to the second (e.g., target) virtual environment, based on prompts related to attributes of the target environment. For example, if the second virtual environment is a virtual environment for conducting business-related tasks, avatar classification module 215 will use generative AI methods to adapt a user's avatar by accessorizing the guest avatar with accessories and/or clothing appropriate for a business-like environment. Similarly, if the second virtual environment is a virtual environment where user's meet to play fantasy games like dungeons and dragons or live-action role-playing, avatar classification module 215 will use generative AI methods to adapt a user's avatar by accessorizing the guest avatar with accessories and/or clothing appropriate for the game being played.

At the conclusion of block 330, the users of the cluster of users have been teleported to the new second (e.g., target) virtual environment, have a guest ID and/or guest profile, and a generated avatar based on the user's avatar from the first virtual environment. Further, the appearance and accessories of the avatar have been adapted to represent the characteristics and/or theme of the second (e.g., target) virtual environment. In embodiments, adapting the appearance and accessories of the avatar to represent the characteristics and/or theme of the second (e.g., target) virtual environment may further comprise identifying, classifying, and or labelling characteristics of the second virtual environment. Using the identified, classified, or labelled characteristics, the system can modify the avatar accordingly. For example, if an avatar in the first virtual platform is depicted as a person wearing clothing or accessories that suggest the person is a sports fan, but the second virtual environment is labelled as a semi-formal space, the system may automatically update the avatar by removing the sports-related accessories and depicting the same (or similar) person as wearing semi-formal clothing.

At block 335, multi-platform aggregation module 225 is configured to generate a new profile prefilled with data collected and aggregated from previous platforms that contain a subset of the profile data required for the second virtual environment. Specifically, multi-platform aggregation module 225 may be configured to generate a new profile on the second virtual environment for each user that does not already have a profile on the second virtual environment. In embodiments, the new profile is prefilled with data that is collected and aggregated from previous platforms that contain a subset of the profile data required for the second virtual environment. In embodiments, the previous platforms include the first virtual environment and may also include additional virtual environments that the respective users have joined. In other words, profile data collected from multiple previous platforms can be used to inform the new avatar profile in the second (e.g., target) virtual environment. This allows the user to maintain multiple digital aliases across different metaverses, while still maintaining a persistent digital identity. This also allows multiple new accounts to be generated that each relate back to previous accounts within various virtual environments (1+N). Ultimately, a user's avatar settings and accessories can be adapted to the theme of the second (e.g., target) virtual environment, to ensure the user's avatar is represented accurately and in accordance with the new platform's design guidelines. Accordingly, with each successive iteration (e.g., joining successive virtual environments), a user can maintain continuity from avatar to avatar, profile to profile, and virtual environment to virtual environment.

In a first exemplary real-world example, Buyer is looking for a home in another location 1,000 mi away and is interested in several neighborhoods. Instead of traveling hours by flight and car to be in-person to look at homes, Buyer prefers to tour homes using an immersive VR experience.

Buyer has found a real estate agent, Agent, at this new location that can accompany her virtually to see homes. Agent has been able to plan to tour homes virtually and notes that the VR environments between homes is sometimes the same and sometimes different. They do not want to be constricted or confused by multiple platforms and places to access homes. Buyer also has a partner, Partner, that will be moving with her, and they would prefer to be able to tour the homes together, and easily move from one home tour to the next as a collective team.

According to aspects of this invention, Buyer, Partner, and Agent each access the various virtual environments in one place to support not only their collaboration and seamless experience as the same identified avatars through multiple VR spaces but assume specifically assigned roles with supporting capabilities enabled. This allows for ease of use, increased engagement, and a better user experience as a result. It also makes collaborative home-searching with multiple people much more seamless.

In a second exemplary real-world example, Influencer has a large social media following. Whenever she posts pictures, many of her followers would send her questions about where to purchase the exact outfit she wears in some of her postings. Influencer would post links to the various websites where her followers could purchase the various pieces of the outfit, such as the hat, dress, shoes, purse, etc. However, her followers found it very tedious to have to create accounts on several different websites to purchase a single outfit. With the invention, a user could just click a single button such as “Purchase this outfit” and as long as they had an account on any of the 5 websites, the other websites would be able to allow pass-through authentication and purchase the items in their size with no added tedious steps.

In a third exemplary real-world example, Graduate recently graduated from university and is about to start his first job outside of school. Graduate could drive from store to store to try-on and compare pieces from each store to update his wardrobe, but this is time consuming. Graduate determines to virtually try-on clothes using VR. He puts on his headset, goes to a first virtual environment, and starts picking out a few items that catch his eye. With a few options in hand, Graduate goes to the virtual fitting rooms. Since this is his first time at the store, he needs to create an avatar that reflects his true physical form. Graduate goes through the creation process, tediously crafting his online digital twin. It takes time but, in the end, he is delighted to see a realistic rendering of how he looks wearing the different outfits he selected, with the ability to quickly change items with ease. However, Graduate does not want to buy the first items he finds. He wants to browse other stores too. However, Graduate soon realizes that he has to create yet another realistic avatar to try on clothes at a second store, at a third store, and again at a fourth store. Graduate's eagerness to explore more options quickly fades as even the idea of needing to meticulously go through yet another store's avatar creation process makes him think twice about his decision to keep browsing.

According to aspects of the invention, Graduate can easily try-on clothes in any store by bringing along his digital avatar wherever he goes. Graduate can easily try on clothes from multiple retailers without the need to repeatedly go through extensive avatar onboarding processes for each store. When Graduate visits the second store, an identical avatar is created based on his avatar from the first store, though translated/adapted into the look and feel of the second store.

In a fourth exemplary real-world example, Job Applicant is looking for a job and comes across multiple positions that appear to match his experience and background. Job Applicant applies for a job with First Company by uploading his curriculum vitae (CV). Even though First Company's platform has stored a copy of the CV, Job Applicant is still required to input information about his experience, education, skills, and abilities. This process is time consuming and monotonous. After applying for a position with First Company, Job Applicant moves to a different platform to apply for a position with Second Company, where he goes the same time-consuming and monotonous process.

According to aspects of the invention, Job Applicant can easily apply to jobs with multiple companies bringing along his digital data wherever he goes. Job Applicant can skip the process of repeatedly filling in information about his experience, education, skills, and abilities. When Job Applicant applies to Second Company, an identical profile is created based on his profile data from First Company, though translated/adapted into requirements of the Second Store.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a processor set, a cluster of users by learning from their interactions in a first virtual environment;
classifying, by the processor set, characteristics of an avatar associated with each user of the cluster of users in the first virtual environment;
generating, by the processor set, a secure portal visible only to users of the cluster of users to teleport to a second virtual environment;
generating, by the processor set, a guest profile and a guest avatar in the second virtual environment for each user of the cluster of users, wherein the guest avatar is based on the avatar associated with each user of the cluster of users in the first virtual environment;
adapting, by the processor set, the guest avatar for each user of the cluster of users based on a theme of the second virtual environment; and
generating, by the processor set, a new profile prefilled with data collected from previous virtual environments that contain a subset of profile data required for the second virtual environment.

2. The computer-implemented method of claim 1, further comprising replacing, by the processor set, the guest profile with the generated new profile.

3. The computer-implemented method of claim 1, wherein the identifying further comprises:
logging, by the processor set, interactions between users of the cluster of users in the first virtual environment; and
identifying, by the processor set, user groups using machine learning clustering.

4. The computer-implemented method of claim 1, wherein the classifying further comprises:
receiving, by the processor set from a first user of the cluster of users, updated characteristics of the avatar associated with the first user; and
generating, by the processor set, at least one label describing the updated characteristics of the avatar associated with the first user.

5. The computer-implemented method of claim 1, wherein the generating a secure portal further comprises:
maintaining, by the processor set, a temporary session-based record for each user of the cluster of users, wherein the temporary session-based record comprises pointers to a current profile associated with each user of the cluster of users; and
creating, by the processor set, a new session in the second virtual environment.

6. The computer-implemented method of claim 1, further comprising generating, by the processor set, an invitation to join a new session in the second virtual environment using the secure portal.

7. The computer-implemented method of claim 1, wherein the adapting further comprises generating, by the processor set, a representation of the avatar associated with each user of the cluster of users from the first virtual environment in the second virtual environment.

8. A computer program product comprising one or more computer readable storage media having program instructions collectively stored on the one or more computer readable storage media, the program instructions executable to:
identify a cluster of users by learning from their interactions in a first virtual environment;
classify characteristics of an avatar associated with each user of the cluster of users in the first virtual environment;
generate a secure portal visible only to the users of the cluster of users to teleport to a second virtual environment;
generate a guest profile and a guest avatar in the second virtual environment for each user of the cluster of users, wherein the guest avatar is based on the avatar associated with each user of the cluster of users in the first virtual environment;
adapt the guest avatar for each user of the cluster of users based on a theme of the second virtual environment; and
generate a new profile prefilled with data collected from previous virtual environments that contain a subset of profile data required for the second virtual environment.

9. The computer program product of claim 8, wherein program instructions are further executable to replace the guest profile with the generated new profile.

10. The computer program product of claim 8, wherein program instructions are further executable to:
log interactions between users of the cluster of users in the first virtual environment; and
identify user groups using machine learning clustering.

11. The computer program product of claim 8, wherein program instructions are further executable to:
receive, from a first user of the cluster of users, updated characteristics of the avatar associated with the first user; and
generate at least one label describing the characteristics of the updated avatar associated with the first user.

12. The computer program product of claim 8, wherein program instructions are further executable to:
maintain a temporary session-based record for each user of the cluster of users, wherein the temporary session-based record comprises pointers to a current profile associated with each user of the cluster of users; and
create a new session in the second virtual environment.

13. The computer program product of claim 8, wherein program instructions are further executable to generate an invitation to join a new session in the second virtual environment using the secure portal.

14. The computer program product of claim 8, wherein program instructions are further executable to generate a representation of the avatar associated with each user of the cluster of users from the first virtual environment in the second virtual environment.

15. A system comprising:
a processor set, one or more computer readable storage media, and program instructions collectively stored on the one or more computer readable storage media, the program instructions executable to:
identify a cluster of users by learning from their interactions in a first virtual environment;
classify characteristics of an avatar associated with each user of the cluster of users in the first virtual environment;
generate a secure portal visible only to users of the cluster of users to teleport to a second virtual environment;
generate a guest profile and a guest avatar in the second virtual environment for each user of the cluster of users, wherein the guest avatar is based on the avatar associated with each user of the cluster of users in the first virtual environment;
adapt the guest avatar for each user of the cluster of users based on a theme of the second virtual environment; and
generate a new profile prefilled with data collected from previous virtual environments that contain a subset of profile data required for the second virtual environment.

16. The system of claim 15, wherein program instructions are further executable to:
log interactions between users of the cluster of users in the first virtual environment; and
identify user groups using machine learning clustering.

17. The system of claim 15, wherein program instructions are further executable to:
receive, from a first user of the cluster of users, updated characteristics of the avatar associated with the first user; and
generate at least one label describing the characteristics of the updated avatar associated with the first user.

18. The system of claim 15, wherein program instructions are further executable to:
maintain a temporary session-based record for each user of the cluster of users, wherein the temporary session-based record comprises pointers to a current profile associated with each user of the cluster of users; and
create a new session in the second virtual environment.

19. The system of claim 15, wherein program instructions are further executable to generate an invitation to join a new session in the second virtual environment using the secure portal.

20. The system of claim 15, wherein program instructions are further executable to generate a representation of the avatar associated with each user of the cluster of users from the first virtual environment in the second virtual environment.
